(19) United States
(12) Patent Application Publication
(10) Pub. No.: US 2006/0073235 A1
(43) Pub. Date: Apr. 6, 2006

(54) Convertible injection molding system, apparatus, and method

(76) Inventor: Michael D. Ringer SR., Leominster, MA (US)

Correspondence Address: BROMBERG & SUNSTEIN LLP, 125 SUMMER STREET, BOSTON, MA, 02110-1618, US

(21) Appl. No.: 11/219,318

(22) Filed: Sep. 2, 2005

Related U.S. Application Data
(60) Provisional application No. 60/606,936, filed on Sep. 3, 2004.

(51) Int. Cl. B29C 45/22

(52) U.S. Cl. 425/556

(57) ABSTRACT

A convertible injection molding system uses a standardized, reusable mold frame (base) and modular molds formed from various combinations of standardized stack components. The mold base can support one or more stacks. Blank stack components include a cavity block, a core block, a primary support insert, a secondary support insert, an ejector retainer plate, an ejector plate insert, and a clamp plate insert. These components can be assembled into four different configurations with three different opening/closing sequences.

### PRIORITY

This application claims priority from U.S. Provisional Patent Application No. 60/606,936, which was filed on Sep. 3, 2004, and which is hereby incorporated herein by reference in its entirety.

### FIELD OF THE INVENTION

The present invention relates generally to injection molding, and more particularly to a convertible injection molding system, apparatus, and method.

### BACKGROUND OF THE INVENTION

In a typical injection molding system, one or more materials (such as molten plastic or metal) are injected into a mold in order to form a molded part. The mold includes one or more molding chambers for receiving the injected material(s). After a material is injected, the material is typically allowed to set for some period of time, after which another material may be injected. When the molded part is complete, the molded part is ejected from the mold, for example, by externally actuating various ejector components that are built into the mold.

Thus, an injection molding machine typically includes at least an injection mechanism for causing injection of one or more materials into a mold and an ejection mechanism for ejecting the molded part (e.g., by activating the ejector components in the mold). Conceptually, the mold fits into the injection molding machine between the injection mechanism and the ejection mechanism.

The mold typically includes two separate halves, each half defining a portion of each molding chamber. One of the mold halves is mounted onto the injection side of the injection molding machine, while the other mold section is mounted onto the moveable ejector side of the injection molding machine. During molding, the two sections are typically forced into contact with one another to form the molding chamber(s), for example, by forcing the movably mounted mold section against the fixedly mounted mold section. After the mold sections are in contact, the material(s) can be injected into the molding chamber(s).

As known in the art, each of the mold sections may be composed of multiple interconnected modules. For example, as described in published PCT application number WO 03/031141 A1 (hereinafter referred to as the “Person PCT application”), a first mold section may include a first mold module, a drive module, and a distributing module, while a second mold section may include a second mold module, an ejector module, an engaging module, and a guide module. The first mold section may be fixedly mounted within the injection molding machine and the second mold section may be movably mounted in the injection molding machine, in which case the second mold section may be moved into contact with the first mold section in order to form one or more mold chamber(s) for the injection molding process. The engaging module, together with an outer locking means, locks the second mold module against the first mold module and absorbs the forces which act to separate the first and the second mold modules from each other during the injection molding process. The guide module supports the second mold module, the ejector module, and the engaging module to ensure that they move in a suitable fashion in relation to the first mold section. Multiple-part molds are also discussed in U.S. Pat. Nos. 4,274,617; 5,837,086; and 6,652,263.

The ejection mechanism may include a replaceable ejector plate packet. Published German patent application number DE10059045 describes an injection molding machine having a replaceable ejector plate packet that is attached to a base ejector plate packet by a bolt with a flange that cooperates with a curved recess at the base of a cross-bar fitted into a slot in the base packet.

The ejection mechanism in the injection molding machine may include an actuator that is directly or indirectly coupled to the ejector components of the mold and can be hydraulically or electrically operated to actuate the ejector components of the mold. In injection molding machines that do not include a hydraulically-operated actuator, the ejector components of the mold may be actuated in other ways. For example, a portion of the mold may be moved within the injection molding machine so as to engage the ejector components of the mold with an ejection actuator that is fixedly attached to the injection molding machine. Such an injection mechanism can be implemented using a HASCO® guided ejector pull back device (part number Z165) that is incorporated into the movable portion of the mold and a HASCO® ejector rod (part number Z166) that is fixedly attached to the injection molding machine. In order to eject the molded part from the mold, the movable portion of the mold may be moved so that the guided ejector pull back device engages with the ejector rod, thereby actuating the ejector components of the mold.

All of the above-referenced patents and patent applications are hereby incorporated herein by reference in their entireties.

### SUMMARY OF THE INVENTION

A convertible injection molding system uses a standardized, reusable mold frame (base) and modular inserts formed from various combinations of standardized components and when combined are known as a stack. The mold base can support one or more stacks. A stack is the combination of the standardized blank mold components which include, but are not limited to, a cavity block, a core block, a primary support insert, a secondary support insert, an ejector retainer plate, an ejector plate insert, and a clamp plate insert. These components can be assembled into four different configurations with three different opening/closing sequences. Specifically, the mold components can be assembled into a two plate configuration utilizing the cavity block, the core block, the primary support insert, the ejector retainer plate, and the ejector plate insert; a two plate configuration with sleeves utilizing the cavity block, the core block, the primary support insert, the ejector retainer plate, the ejector plate insert, and the clamp plate insert; a floating core plate configuration utilizing the cavity block, the core block, the primary support insert, the secondary support insert, the ejector retainer plate, and the ejector plate insert; and a floating core plate configuration with sleeves utilizing the cavity block, the core block, the primary support insert, the secondary support insert, the ejector retainer plate, the ejector plate insert, and the clamp plate insert. All of these configurations, combined with additional alignment components and other incendiary components, make up what is referred to as a “blank stack” and are used in the manufacture of the final assembly which will fulfill the expected geometry requirements and is now referred to as the “stack”.

Thus, in accordance with one aspect of the invention there is provided injection molding apparatus comprising a plurality of stack components including at least a cavity block, a core block, a primary support insert, a secondary support insert, an ejector retainer plate, an ejector plate insert, and a clamp plate insert. The stack components can be assembled into at least four mold configurations including a two plate configuration utilizing the cavity block, the core block, the primary support insert, the ejector retainer plate, and the ejector plate insert; a two plate configuration with sleeves utilizing the cavity block, the core block, the primary support insert, the ejector retainer plate, the ejector plate insert, and the clamp plate insert; a floating core plate configuration utilizing the cavity block, the core block, the primary support insert, the secondary support insert, the ejector retainer plate, and the ejector plate insert; and a floating core plate configuration with sleeves utilizing the cavity block, the core block, the primary support insert, the secondary support insert, the ejector retainer plate, the ejector plate insert, and the clamp plate insert.

The stacks fit into one of many standard mold base configurations having standard interfaces for supporting interchangeability within the different mold bases. The mold base typically includes a standard hot runner that interfaces with a standard gate position in the cavity block. The mold base typically includes a standard ejector interface that interfaces with ejector components located within a predetermined area of the ejector plate insert. The mold base typically includes multiple fluid circuits for interfacing with standard inlets and outlets on the stack. The fluid circuit can be a water circuit for cooling. The fluid circuit can also be used for a fluid circuit for actuating any mechanisms within the confines of the stack.

The two plate configurations typically support an opening sequence involving one parting line with no latch locks or early return mechanisms. The floating core plate configurations are typically capable of supporting two opening sequences utilizing the same floating core plate, specifically a first opening sequence involves the use of latch locks with delayed pull bar and early return mechanisms to open a main parting line before opening a second parting line and a second opening sequence involves the use of latch locks with no delay pull bar and no early return mechanisms to open a second parting line before opening a main parting line.

The molds typically include a so-called “floating core” in which the core block is coupled to the primary support insert in the assembled mold base in such a way that the combined core block and primary support insert are able to move relative to a floating core plate (if a floating core plate option is used) or ejector housing plate of the mold base. The floating core allows the core block to automatically align with the fixed cavity block when the mold base is closed. A plurality of spring packs may be operatively coupled between the floating core plate or ejector housing plate and the primary support insert for holding the core block in a semi-fixed position relative to the primary support insert while allowing sufficient movement of the assembled core block and primary support insert for automatic alignment. Each spring pack may include a stripper bolt, a number of spring washers arranged on the stripper bolt, and a cap, in which case each stripper bolt may include a proximal end coupled to the floating core plate or ejector housing plate and a distal end onto which the cap is mounted for making contact with the primary support insert to apply sufficient pressure to the face to hold the assembled unit in place but still allow enough movement for proper alignment with the cavity block.

The primary support insert, the floating core plate support insert, the ejector retainer plate, the ejector plate insert, and the clamp plate insert may be formed from stainless steel for corrosion resistance and there is no hardening requirement. The cavity block and the core block, however, are typically formed from a tool steel material that usually requires hardening. Guide lock pin holes, assembly guide pin holes, and gate detail are typically formed in the cavity block after hardening. Similarly, guide lock pin holes and dowel pin holes are typically formed in the core block after hardening.

Both the blank cavity block and the blank core block may include extra material so that a sufficient amount of material, required for a particular application, can be removed from each block to result in a predetermined combined thickness of the two blocks.

The mold base typically includes standard interfaces for interfacing with the at least one stack. Each stack is interchangeable with the different mold bases.

In accordance with another aspect of the invention there is provided an injection molding kit having component parts capable of being pre-assembled for use in an injection molding system, the kit comprising the combination of a cavity block; a core block; a primary support insert; an optional floating core plate support insert; an ejector retainer plate; an ejector plate insert; and an optional clamp plate insert. The blank mold components can be assembled into at least four mold configurations including a two plate configuration utilizing the cavity block, the core block, the primary support insert, the ejector retainer plate, and the ejector plate insert; a two plate configuration with sleeves utilizing the cavity block, the core block, the primary support insert, the ejector retainer plate, the ejector plate insert, and the clamp plate insert; a floating core plate configuration utilizing the cavity block, the core block, the primary support insert, the secondary support insert, the ejector retainer plate, and the ejector plate insert; and a floating core plate configuration with sleeves utilizing the cavity block, the core block, the primary support insert, the secondary support insert, the ejector retainer plate, the ejector plate insert, and the clamp plate insert.

The kit may also include latch locks which, when used with the floating core plate configurations, allows for opening a second parting line before opening a main parting line. The kit may include latch locks with delayed pull bar and early return mechanisms which, when used with the floating core plate configurations, allows for opening a main parting line before opening a second parting line.

### BRIEF DESCRIPTION OF THE DRAWINGS

The foregoing features of the invention will be more readily understood by reference to the following detailed description, taken with reference to the accompanying drawings, in which:

FIG. 1 is a schematic diagram showing exemplary injection molding apparatus including a mold base with optional floating core plate and two stacks in accordance with an embodiment of the present invention;

FIG. 2 is a schematic diagram showing the injection molding apparatus of FIG. 1 installed into an injection molding machine in accordance with an embodiment of the present invention;

FIG. 3 shows a complete set of standardized “blank” mold components in accordance with an exemplary embodiment of the present invention;

FIG. 4 shows a two plate configuration in accordance with an exemplary embodiment of the present invention;

FIG. 5 shows a two plate with sleeve configuration in accordance with an exemplary embodiment of the present invention;

FIG. 6 shows a floating core plate configuration in accordance with an exemplary embodiment of the present invention;

FIG. 7 shows the relevant components of a spring pack in accordance with an exemplary embodiment of the present invention;

FIG. 8 shows a overlapping material in the cavity block and the core block in accordance with an exemplary embodiment of the present invention;

FIG. 9 shows the standard “L” dimension in accordance with an exemplary embodiment of the present invention;

FIG. 10 shows the standardized gate location relative to the cavity block, in accordance with an exemplary embodiment of the present invention;

FIG. 11 shows the standardized gate location relative to a proposed cavity design, in accordance with an exemplary embodiment of the present invention;

FIG. 12 shows the main split plane in accordance with an exemplary embodiment of the present invention;

FIG. 13 shows the cavity block with completed cavity in accordance with an exemplary embodiment of the present invention;

FIG. 14 shows a front view of the allowable ejector area in accordance with an exemplary embodiment of the present invention;

FIG. 15 shows the detail of a pneumatic slide unit with respect to the cavity block, in accordance with an exemplary embodiment of the present invention;

FIG. 16 shows a standard lifter assembly in accordance with an exemplary embodiment of the present invention;

FIG. 17 shows a layout of air and water lines in the cavity block, in accordance with an exemplary embodiment of the present invention;

FIG. 18 shows the position of water inlets and outlets on the manifold plate, in accordance with an exemplary embodiment of the present invention;

FIG. 19 shows a large slider with cooling and a small slider without cooling, in accordance with an exemplary embodiment of the present invention;

FIG. 20 shows the guide lock pin holes, the assembly guide pin holes, and the gate detail in the cavity block in accordance with an exemplary embodiment of the present invention;

FIG. 21 shows the guide lock pin holes and the dowel pin holes in the core block in accordance with an exemplary embodiment of the present invention;

FIG. 22 shows a top view and a side view (from the cavity block) of a fully assembled 2P-S stack in accordance with an exemplary embodiment of the present invention;

FIG. 23 shows a clamp side view and an operator side view of a fully assembled 2P-S stack in accordance with an exemplary embodiment of the present invention;

FIG. 24 shows perspective views of the core side and the cavity side of a 2P-S stack in accordance with an exemplary embodiment of the present invention;

FIG. 25 shows additional side views of a fully assembled 2P-S stack in accordance with an exemplary embodiment of the present invention;

FIG. 26 shows additional side views of a fully assembled 2P-S stack, including a non-operator side view, in accordance with an exemplary embodiment of the present invention;

FIG. 27 shows mold action sequence and assembly instructions for a standard two plate assembly, in accordance with an exemplary embodiment of the present invention;

FIG. 28 shows a top view and a side view (from the cavity block) of a fully assembled FCP-S stack in accordance with an exemplary embodiment of the present invention;

FIG. 29 shows a clamp side view and an operator side view of a fully assembled FCP-S stack in accordance with an exemplary embodiment of the present invention;

FIG. 30 shows perspective views of the core side and the cavity side of a FCP-S stack in accordance with an exemplary embodiment of the present invention;

FIG. 31 shows additional side views of a fully assembled FCP-S stack in accordance with an exemplary embodiment of the present invention;

FIG. 32 shows additional side views of a fully assembled FCP-S stack, including a non-operator side view, in accordance with an exemplary embodiment of the present invention; and

FIG. 33 shows mold action sequences and assembly instructions for a floating core plate assembly, in accordance with exemplary embodiments of the present invention.

### DETAILED DESCRIPTION OF A PREFERRED EMBODIMENT

A convertible injection molding system uses a standardized, reusable mold frame (base) and modular molds formed from various combinations of standardized mold components. As opposed to prior art systems, which generally require custom mold frame components for each mold that are usable only for that mold, a standardized, reusable mold frame has standardized interfaces for use with molds having different internal geometries and features. Substantial functionality may be incorporated into the mold frame components in order to simplify the mold components.

In an exemplary embodiment of the present invention, an injection molding system includes a standardized mold base that receives, or is outfitted to receive, one or more stacks. The injection molding machine typically includes, among other things, an injection mechanism for injecting one or more materials into the mold(s) and an ejection mechanism for ejecting a molded part from the mold(s). The stacks interface with the injection mechanism of the injection molding machine through a runner clamp plate of the mold base and with the ejection mechanism of the injection molding machine through an ejector clamp plate of the mold base. The runner clamp plate includes a hot runner system for conveying injection molding material to the stacks. The runner clamp plate and the ejector clamp plate can be integral components of the injection molding machine or can be separate components that are attached or otherwise installed in the injection molding machine. The runner clamp plate and the ejector clamp plate include standard runner and ejection interfaces, respectively, and are “universal” in that they can interface with machines having different internal geometries.

In an exemplary embodiment of the present invention, a universal mold base, including the runner clamp plate and the ejector clamp plate, is installed into the injection molding machine for receiving one or more stacks. The runner clamp plate is typically attached to a fixed machine plate of the injection molding machine, and the ejector clamp plate is typically attached to a movable machine plate of the injection molding machine. The mold base can be configured to support one or more stacks at a time. For example, the mold base can be configured to support one, two, or four stacks simultaneously. When installed into the injection molding machine, the mold base can be considered part of the machine as opposed to part of the mold.

In an exemplary embodiment of the present invention, the stacks are modular, and include a series of interconnected modules or plates. The modules or plates are standardized and can be arranged in various combinations to meet specific user requirements. Standardized “blank” mold components can be produced in quantity and provided to a toolmaker, who designs tools around the standardized components. The use of standardized components typically reduces the overall toolmaking cost and time.

Stacks (including the mold base) are typically pre-assembled so that the unitary stack can be shipped or stored as a single unit and help to reduce the likelihood of damage or loss of the stack components. The stacks include standard runner and ejection interfaces as well as standard water and air interfaces.

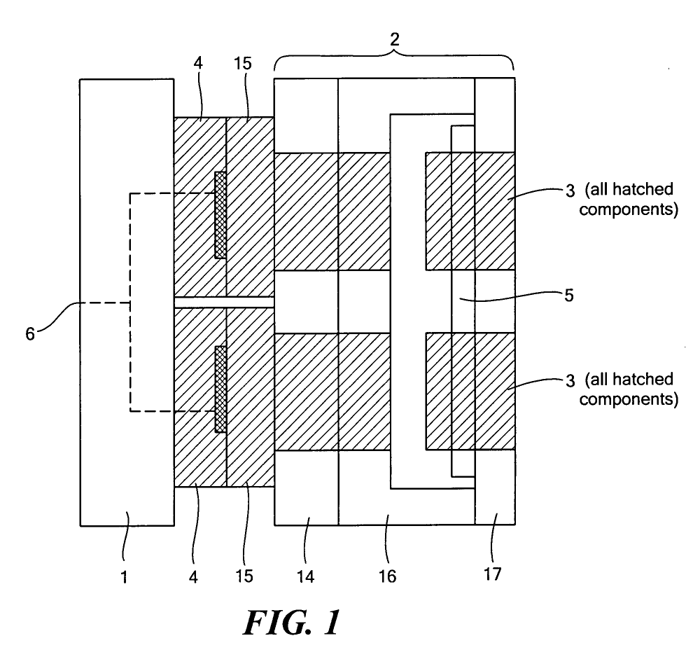

FIG. 1 is a schematic diagram showing exemplary ejection molding apparatus including a mold base with optional floating core plate and two stacks in accordance with an embodiment of the present invention. In this example, two stacks 3 (i.e., the hatched components) are installed to the face of the runner clamp plate 1 and internally within the ejector clamp plate system 2. The ejector clamp plate system 2 includes, among other things, floating core plate 14, ejector housing plate 16, ejector plate 5, clamp plate 174. The runner clamp plate 1 includes a runner system 6 for conveying injection molding material to the stacks 3. Each stack 3 includes, among other things, a cavity block 4 that is coupled to the runner clamp plate 1 for receiving injection molding material from the runner system 6, a core block 15, a primary support insert to which the core block 15 is attached so that the core block 15 and primary support inserts are movably coupled to the floating core plate 14, a secondary insert attached to the ejector housing plate 16, an ejector retainer plate and an ejector plate insert that interoperate with the ejector plate 5, and a clamp plate insert attached to the clamp plate 17. For the sake of convenience, the primary support insert, the secondary insert, the ejector retainer plate, the ejector plate insert, and the clamp plate insert are not numbered in this figure. The various stack components are described in greater detail below.

If the floating core plate option is not used, then the floating core plate 14 is not installed in the mold base, and the corresponding support insert is not used in the stack. In this situation, the support insert associated with the ejector housing plate 16 is considered to be the primary support insert (as it would then be the only support insert used in the stack), the core block 15 is attached to the support insert so that the core block 15 and support insert are movably coupled to the ejector housing plate 16, and the ejector clamp plate system 2 excludes the floating core plate 14.

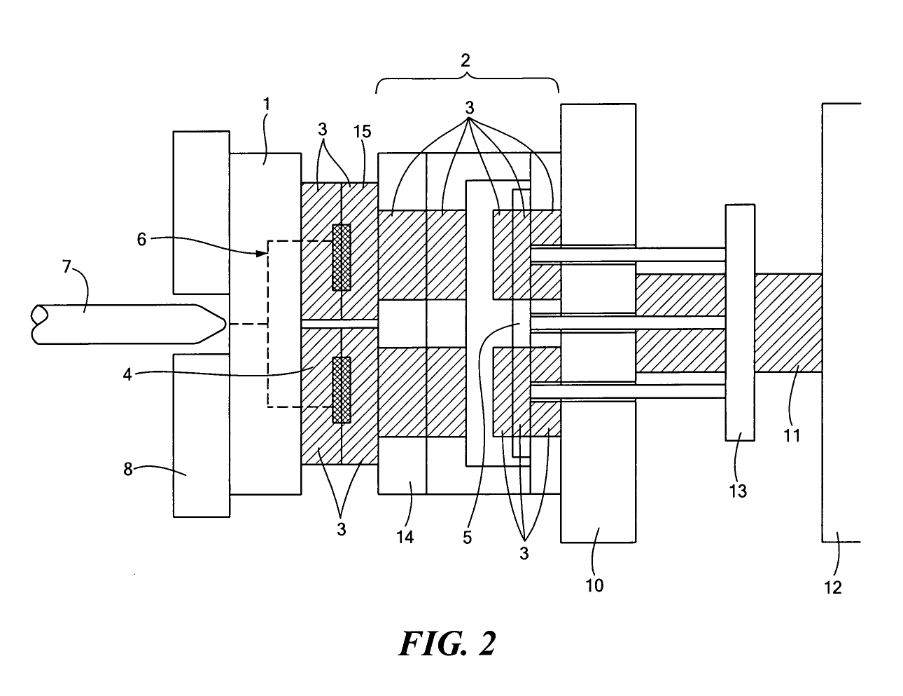

FIG. 2 is a schematic diagram showing the ejection molding apparatus of FIG. 1 installed into an injection molding machine in accordance with an embodiment of the present invention. The runner clamp plate 1 with cavity block(s) 4 is attached to a fixed machine plate 8 of the injection molding machine. The ejector clamp plate system 2 with core block(s) and other stack components is attached to a movable machine plate 10 of the injection molding machine. The ejector clamp plate system 2 is moved by cylinder 11 that is attached to machine base 12 in order to open and close the mold base at the parting line between the cavity block 4 and the core block 15. When the mold base is closed, injection molding material can then be introduced to the stacks 3 through machine injection unit 7 and hot runner 6. The ejector plate 5 in the mold base is actuated by the ejector mechanism 13 in the injection molding machine. The optional floating core plate 14 allows for a second parting line between the floating core plate 14 and the ejector housing plate 16.

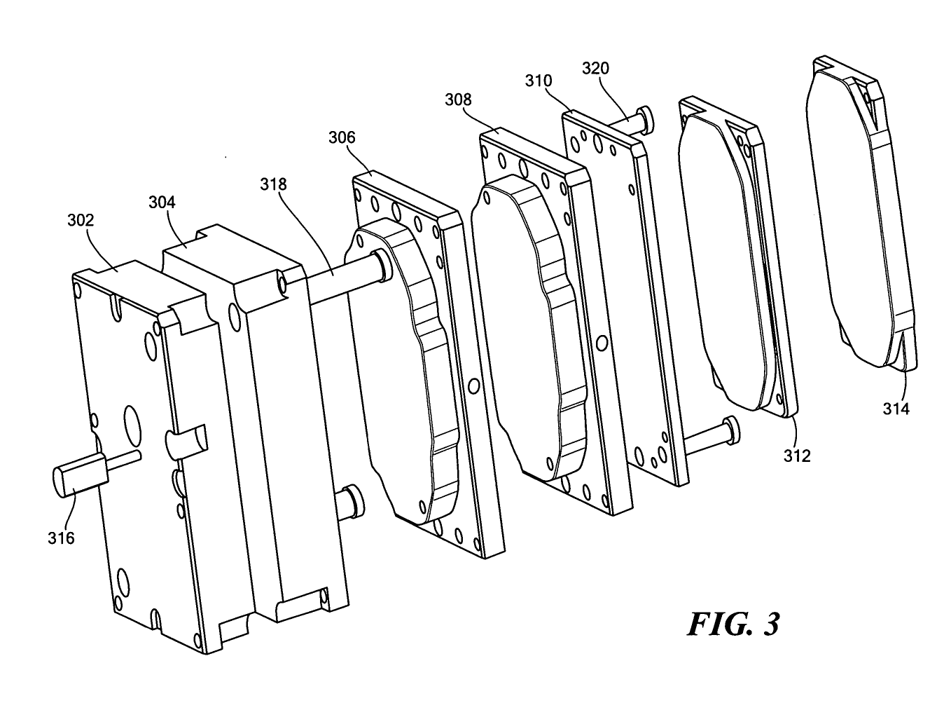

FIG. 3 shows a complete set of standardized “blank” stack components in accordance with an exemplary embodiment of the present invention. The standardized “blank” stack components include a cavity block 302, a core block 304, a primary support insert 306, a secondary support insert 308, an ejector retainer plate 310, an ejector plate insert 312, and a clamp plate insert 314. The cavity block 302 includes a cycle counter 316. The core block includes guide/lock pins 318. The ejector retainer plate 310 includes stroke limiters 320. Other than the cavity block 302 and the core block 304, all of these other stack components are typically manufactured from stainless steel and do not require hardening. The cavity block 302 and core block 304 typically made from tool steel and do require hardening.

In an exemplary embodiment of the present invention, the various mold components can be arranged into four configurations, namely a standard two-plate configuration with no sleeves (referred to hereinafter as the “2P” configuration), a standard two-plate version with sleeves (referred to hereinafter as the “2P-S” configuration), a floating core plate option with no sleeves (referred to hereinafter as the “FCP” configuration), and a floating core plate option with sleeves (referred to hereinafter as the “FCP-S” configuration).

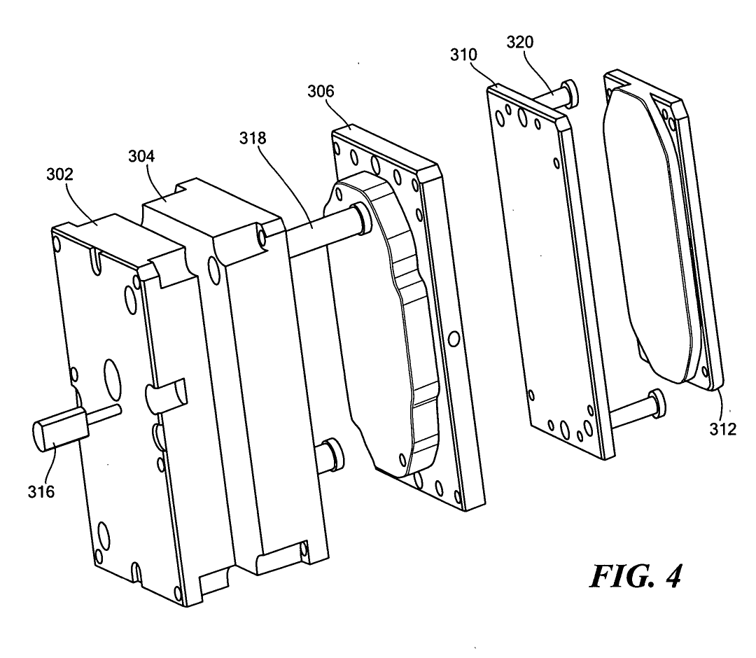

FIG. 4 shows the 2P configuration in accordance with an exemplary embodiment of the present invention. The 2P configuration includes a cavity block 302 with cycle counter 316, a core block 304 with guide/lock pins 318, a primary support insert 306, an ejector retainer plate 310 with stroke limiters 320, and an ejector plate insert 312.

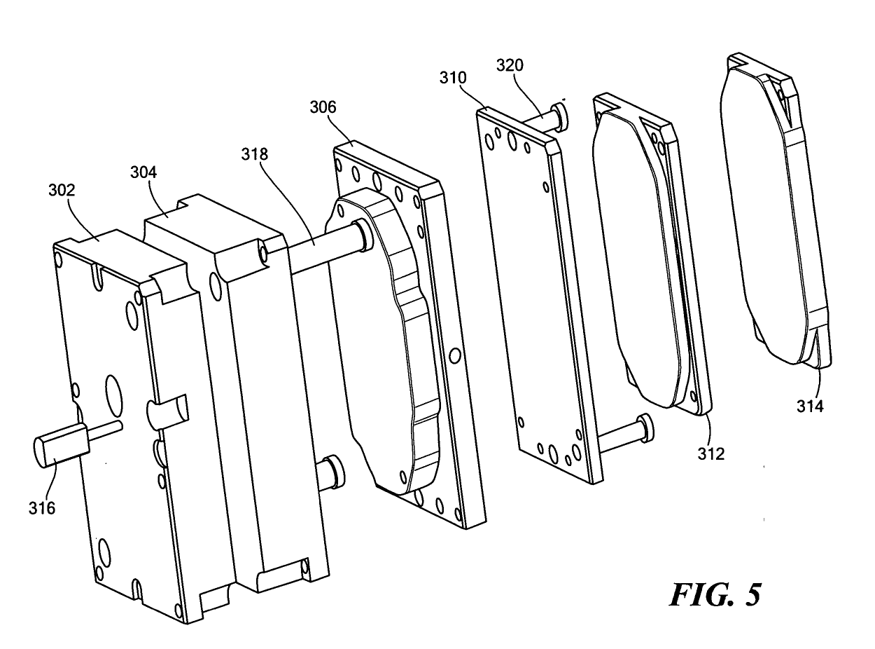

FIG. 5 shows the 2P-S configuration in accordance with an exemplary embodiment of the present invention. The 2P-S configuration includes a cavity block 302 with cycle counter 316, a core block 304 with guide/lock pins 318, a primary support insert 306, an ejector retainer plate 310 with stroke limiters 320, an ejector plate insert 312, and a clamp plate insert 314.

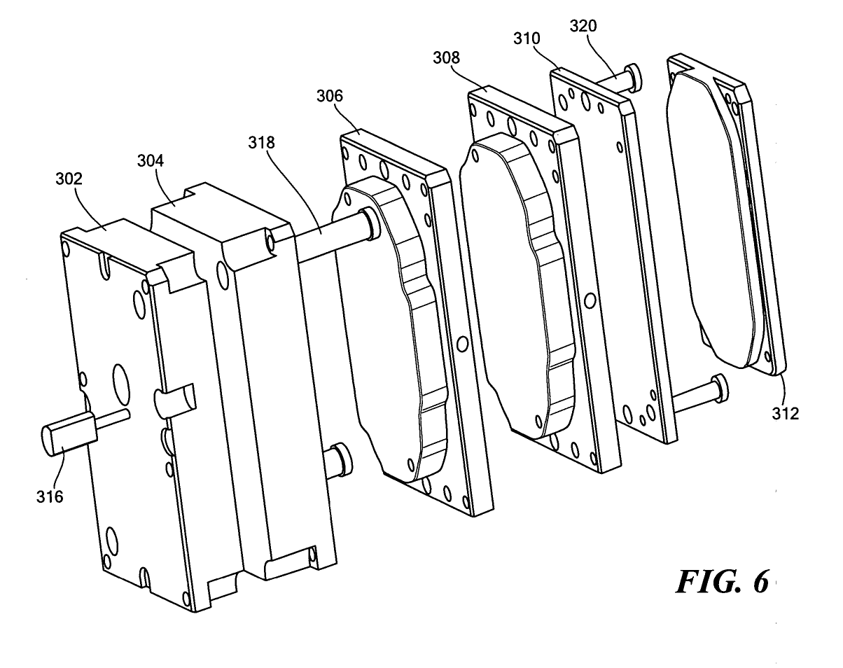

FIG. 6 shows the FCP configuration in accordance with an exemplary embodiment of the present invention. The FCP configuration includes a cavity block 302 with cycle counter 316, a core block 304 with guide/lock pins 318, a primary support insert 306, a secondary support insert 308, an ejector retainer plate 310 with stroke limiters 320, and an ejector plate insert 312.

The FCP-S configuration includes a cavity block 302 with cycle counter 316, a core block 304 with guide/lock pins 318, a primary support insert 306, a secondary support insert 308, an ejector retainer plate 310 with stroke limiters 320, an ejector plate insert 312, and a clamp plate insert 314.

Thus, only one support insert is required unless the floating core plate option is used, in which case two support inserts are required. Also, the clamp plate insert only requires machining if sleeves are required.

The floating core plate option is typically used when a secondary movement is needed within the mold. For example, the floating core plate option may be used to remove steel from the product before the main parting line opens using a collapsible core, to pull a side action on the cavity side of the tool, to remove the core from the plastic before opening the parting line, or to strip the molded part off of the core. The floating core plate option may also be used to perform a secondary movement when the part geometry has a large undercut.

In exemplary embodiments of the present invention, the floating core plate option supports two opening and closing sequences, specifically a first sequence in which the main parting line opens before the second parting line and a second sequence in which the second parting line opens before the first parting line. For the first sequence, latch locks with delayed pull bar and early return mechanisms are used. For the second sequence, latch locks with no delay pull bar and no early return mechanisms are used. It should be noted that the same floating core plate is used for both sequences. It should also be noted that the opening/closing sequence for the 2P embodiments opens and closes one parting line with no parting line lock or early return mechanisms.

The floating core plate option should not be confused with a so-called “floating core,” which is also included in an exemplary embodiment of the present invention. As opposed to a floating core plate option, which allows for a secondary movement in the mold, a “floating core” allows for self-alignment between the cavity block and the core block, for example, to compensate for shifting of plates during assembly or shipment or to compensate for heat expansion. In an exemplary embodiment of the present invention, the core block 304 is allowed to “float” with respect to primary support insert 306 by plus-or-minus 0.2 millimeter. Guide lock pins in the core block 304 align with holes in the cavity block 302 to permit self-alignment of the core block 304 with the cavity block 302.

In an exemplary embodiment of the present invention, the mold base includes four spring packs, arranged substantially at the four corners of the floating core plate 14 (if floating core plate option is used) or the ejector housing plate 2, which push against the primary support insert 306. The pressure of the spring packs against the primary support insert 306 normally holds the core block 304 in a substantially fixed location relative to the cavity block 4, but still allows for movement of the core block 304 relative to the floating core plate or ejector housing plate specifically for the purpose of enabling self-alignment (although such play also allows for unwanted movement, such as during shipping, that can cause misalignment). The first time the mold is closed, the core block 304 self-aligns with the cavity block 302, and the spring packs normally hold the core block 304 in the aligned position unless and until something causes movement of the core block 304.

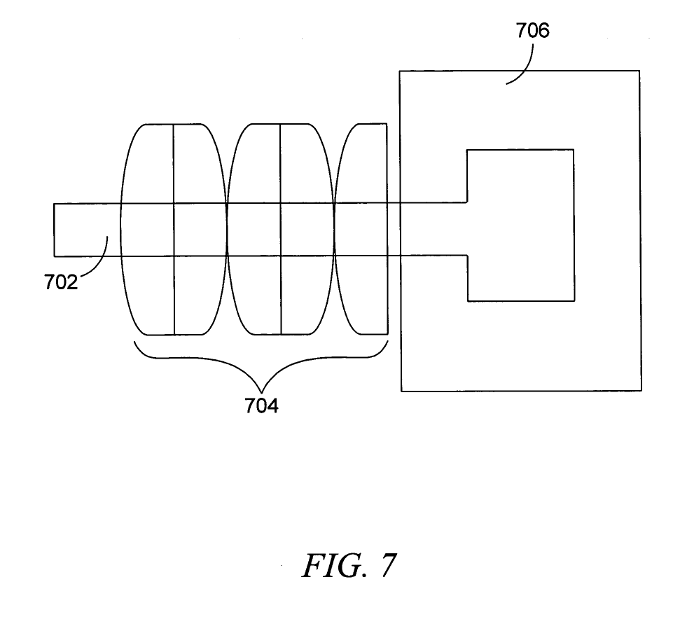

FIG. 7 shows the relevant components of a spring pack in accordance with an exemplary embodiment of the present invention. The spring pack includes a stripper bolt 702, a number of spring washers 704 (e.g., belleville washers), and a cap 706. The stripper bolt 702 is screwed or otherwise mounted at its free end to the floating core plate 14. The cap 706 makes contact with the primary support insert 306. The spring washers 704 are compressed so as to push the cap 706 against the primary support insert 306 with sufficient force to hold the core block 304 in place under normal conditions.

It should be noted that the spring packs are not required for “floating core,” although without spring packs or some other securing mechanism, the core block 304 would move about freely and would likely have to re-align each time the mold is closed. Such frequent re-alignment would likely cause premature wearing of the guide lock pins and holes.

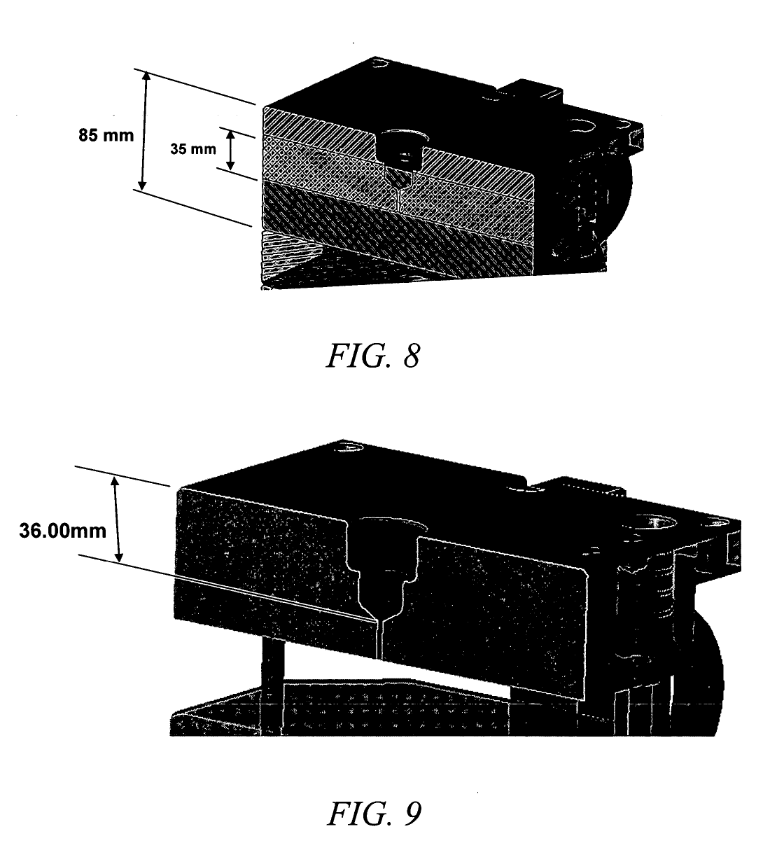

In an exemplary embodiment of the present invention, the combined height of the finished cavity block 302 and core block 304 is 85 millimeters. The rough height of the blank cavity block 302 is approximately 55 millimeters, while the rough height of the blank core block 304 is approximately 65 millimeters. Thus, there is an overlapping material height of approximately 35 millimeters. FIG. 8 shows the overlapping material height in accordance with an exemplary embodiment of the present invention.

In an exemplary embodiment of the present invention, the Husky VG 750 nozzle with plunger style gate is the standard configuration. The cavity block 302 is configured for a standard gate diameter of 1.80 millimeters to match the standard valve stem and is configured with an “L” dimension of 36.00 millimeters. The user configures the part geometry in the cavity block 302 to achieve this “L” dimension. FIG. 9 shows the standard “L” dimension in accordance with an exemplary embodiment of the present invention.

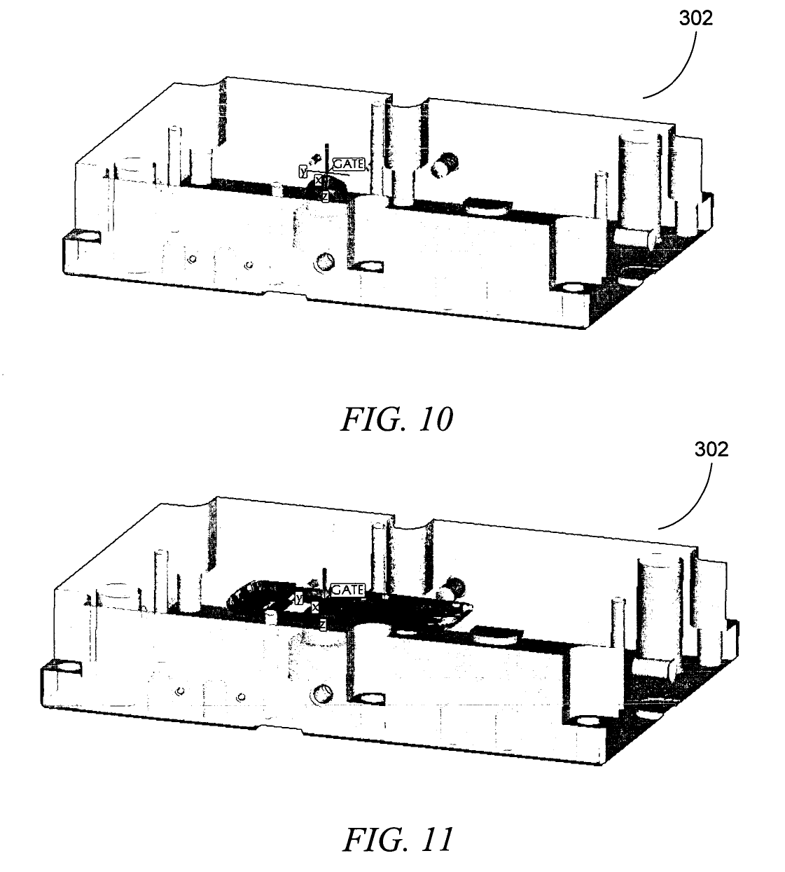

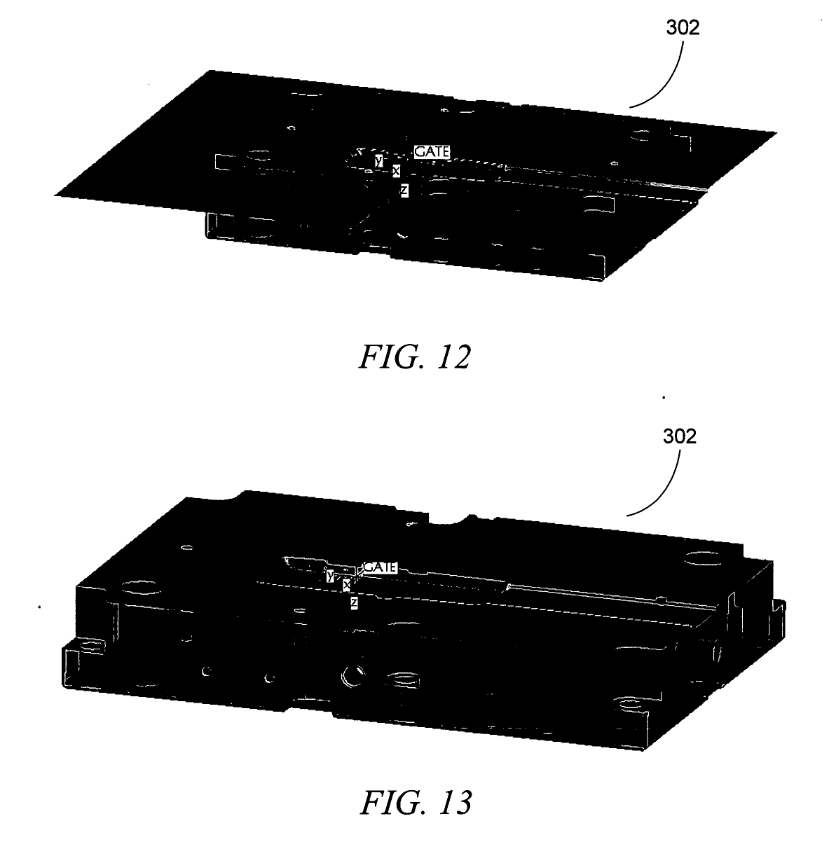

Gate position and shrinkage is typically defined through preliminary ESI work, which typically includes moldflow analysis. The position of the gate will determine the location of the part in the cavity block 302 as well as the overall thickness of the cavity block 302. The parting line on the core block 304 is adjusted to achieve the overall 85 millimeter standard height. The gate location in the blind stack is always in the same position in the stack. Among other things, this makes it possible to have a standardized hot runner. The gate detail and gate diameter are completed after hardening of the cavity block 302. FIG. 10 shows the standardized gate location relative to the cavity block 302, in accordance with an exemplary embodiment of the present invention. FIG. 11 shows the standardized gate location relative to a proposed cavity design, in accordance with an exemplary embodiment of the present invention. Once the gate location is determined, the main split plane is defined and is used to create the cavity shape. FIG. 12 shows the main split plane in accordance with an exemplary embodiment of the present invention. FIG. 13 shows the cavity block 302 with completed cavity in accordance with an exemplary embodiment of the present invention.

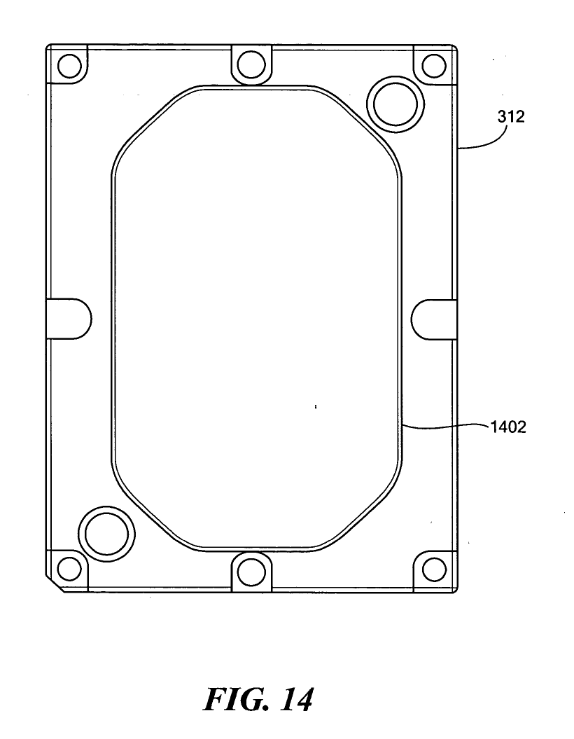

In an exemplary embodiment of the present invention, the mold components are designed such that all ejector components must fit within a predetermined area of the stack. FIG. 14 shows a front view of the allowable area in accordance with an exemplary embodiment of the present invention. Placement of all types of ejectors, including ejector pins, sleeves, and lifters, must be within the area bounded by the bold line 1402. This is the area through the mold base that is inserted. Multiple cavities can be used in each stack, but the ejection must be contained within this area. Slides and other mechanical actions can be designed outside this area. Actuator locks for cavity side slides used in the floating core plate option can be stepped to allow for actuation outside this area.

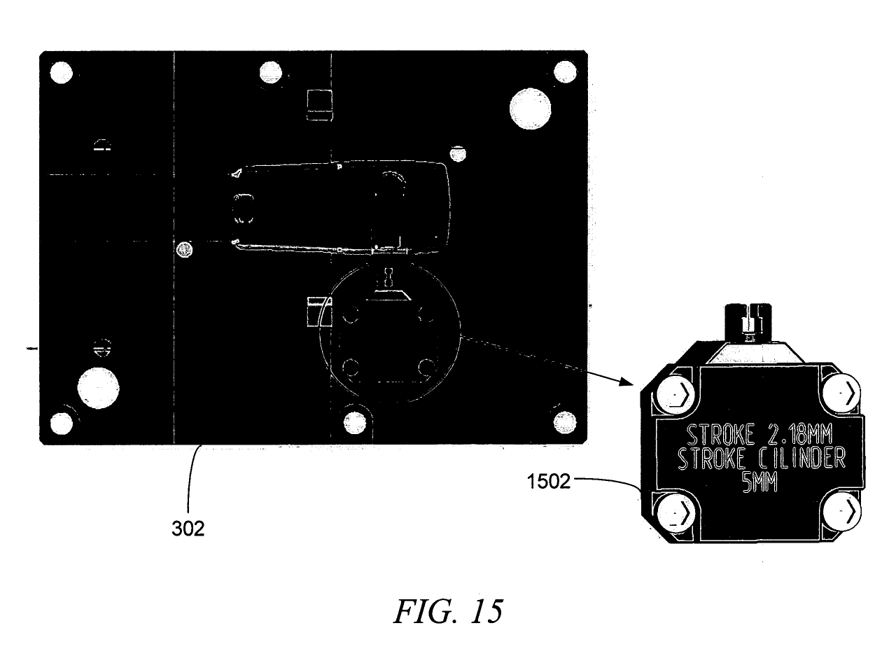

If a pneumatic slide unit is to be used (e.g., to activate underground sliders in the cavity side before the mold opens), air lines are typically added to the cavity block 302 to actuate the toggle side action. One of the water circuit inlet and outlet locations in the hot runner manifold can be used for air if only one water circuit is required in the cavity block 302. In an exemplary embodiment of the present invention, two types of pneumatic slide units can be employed, one having a stroke of 2.18 millimeters and one having a stroke of 3.95 millimeters. FIG. 15 shows the position of a pneumatic slide unit 1502 with respect to the cavity block 302, in accordance with an exemplary embodiment of the present invention.

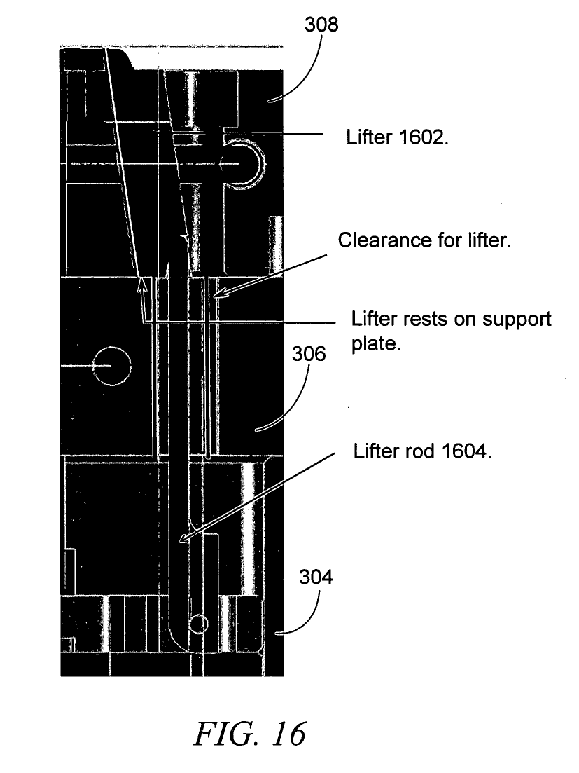

In an exemplary embodiment of the present invention, lifter design is standardized using a standard lifter rod. FIG. 16 shows a lifter assembly in accordance with an exemplary embodiment of the present invention. The lifter 1602 is actuated by lifter rod 1604. Since the lifter rod 1604 is a standard component, it is important that the lifter design be done such that the lifter rod 1604 is perpendicular to the plates in order to keep the length standard. It is also important that the lifter 1602 rest on primary support insert 306.

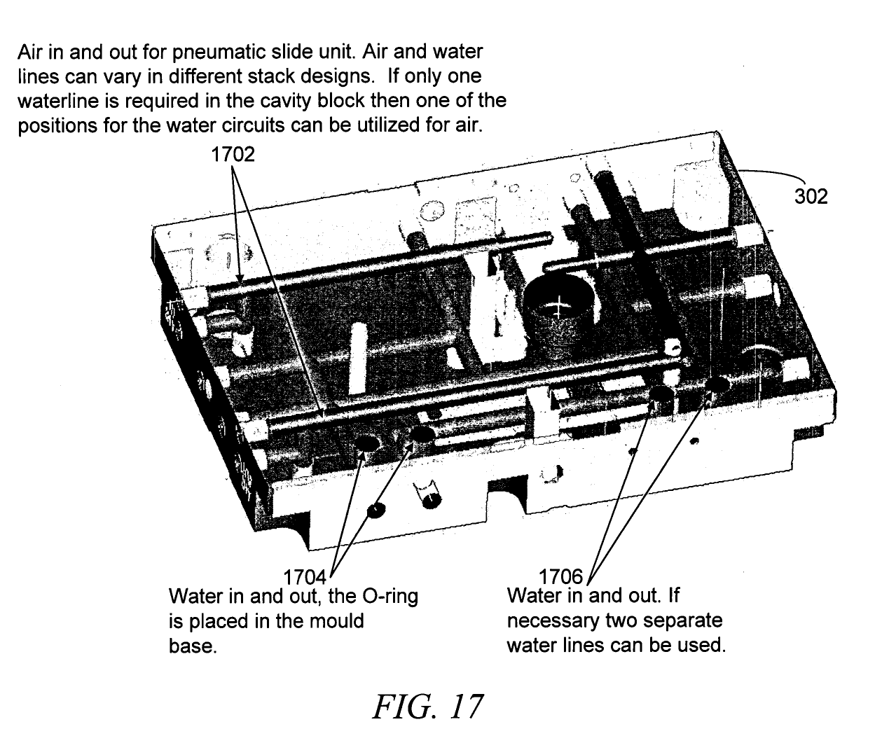

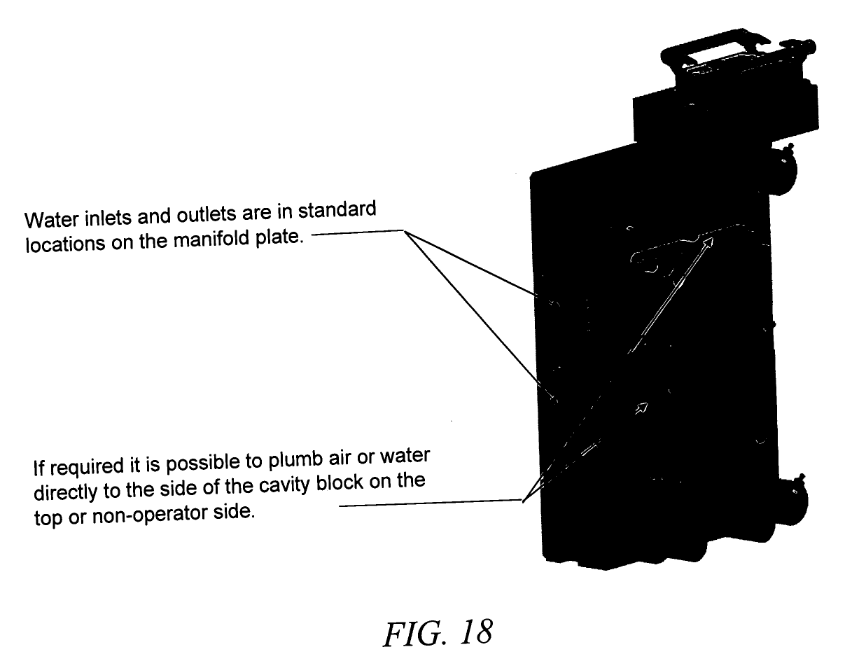

FIG. 17 shows a layout of air and water lines in the cavity side, in accordance with an exemplary embodiment of the present invention. Air inlets and outlets 1702 are provided for the pneumatic slide unit. Water inlets and outlets 1704 and 1706 are also provided. The O-rings for the water inlets and outlets are typically placed in the mold base, and the outside diameter of the O-rings must be taken into consideration during design of the stack. If required, two separate water lines can be used. If only one water line is required in the cavity block, then one of the positions for the water circuits can be used for air. If one of the circuits is not being used, the corresponding inlets and outlets are typically blocked (e.g., with aluminum plates or a pipe plug). If required, it is typically possible to plumb air or water directly to the side of the cavity block 302 on the top or non-operator side. FIG. 18 shows the position of water inlets and outlets on the manifold plate, in accordance with an exemplary embodiment of the present invention.

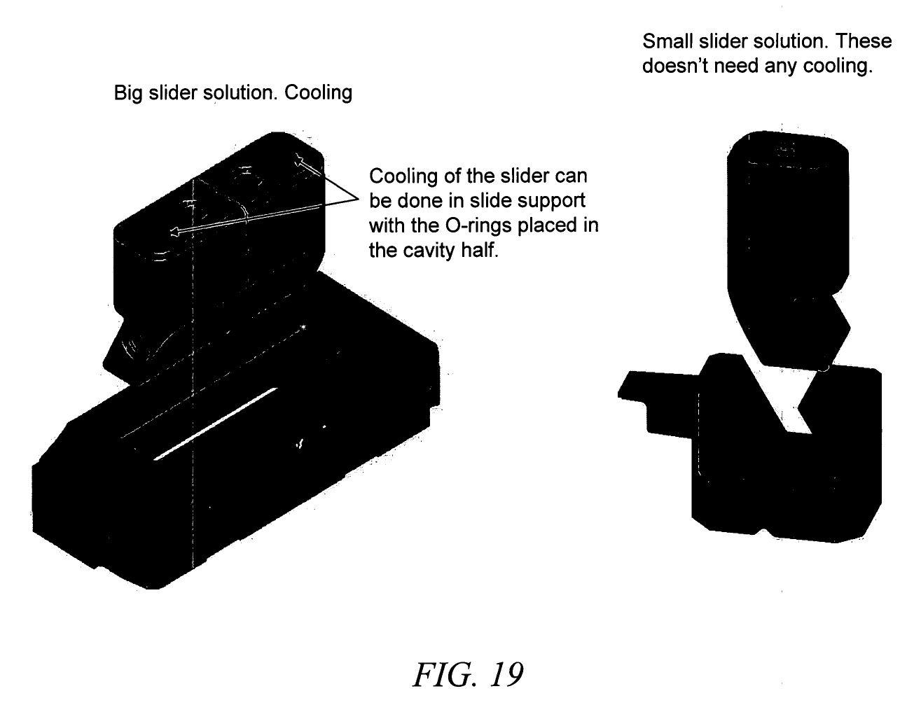

In embodiments of the present invention in which side action sliders are used, it may be necessary to providing cooling for the slider, particularly for large sliders. Cooling of the slider can be done in the slide support with the O-rings placed in the cavity half. FIG. 19 shows a large slider with cooling and a small slider without cooling, in accordance with an exemplary embodiment of the present invention.

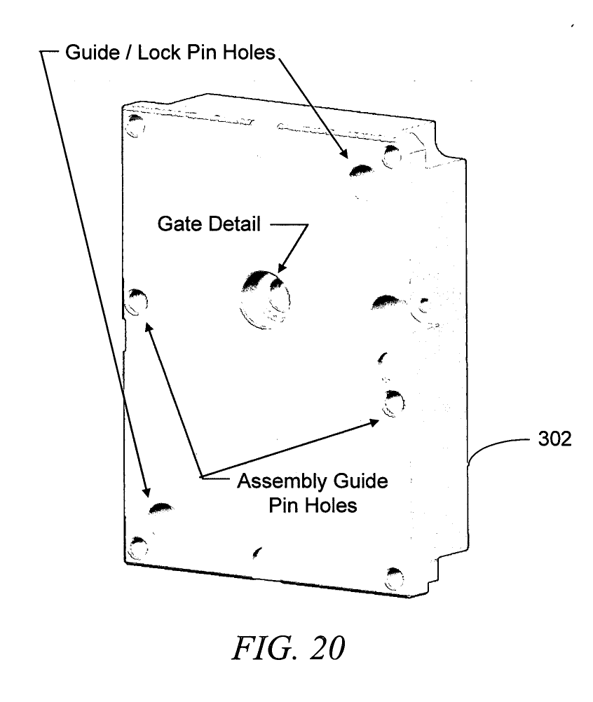

As discussed above, in an exemplary embodiment of the present invention, the cavity block 302 must be hardened. Certain machining is performed after hardening of the cavity block 302. This typically includes machining the guide lock pin holes (e.g., by hard machining, jig grinding, or wire electrical discharge machining (EDM)), machining the assembly guide pin holes (e.g., by hard machining, jig grinding, or wire electrical discharge machining (EDM)) and machining the gate detail. Machining of the guide lock pin holes and the assembly guide pin holes must be in the correct relation to the gate detail location. The assembly guide pin holes are typically machined for a loose fit with the hot runner manifold for ease of assembly. The gate detail must be machined for the standard nozzle (e.g., for Husky VG 750 nozzle with plunger style gate, the gate detail must be machined with an “L” dimension of 36.00 millimeters and a gate diameter of 1.80 millimeters). FIG. 20 shows the guide lock pin holes, the assembly guide pin holes, and the gate detail in the cavity block 302 in accordance with an exemplary embodiment of the present invention.

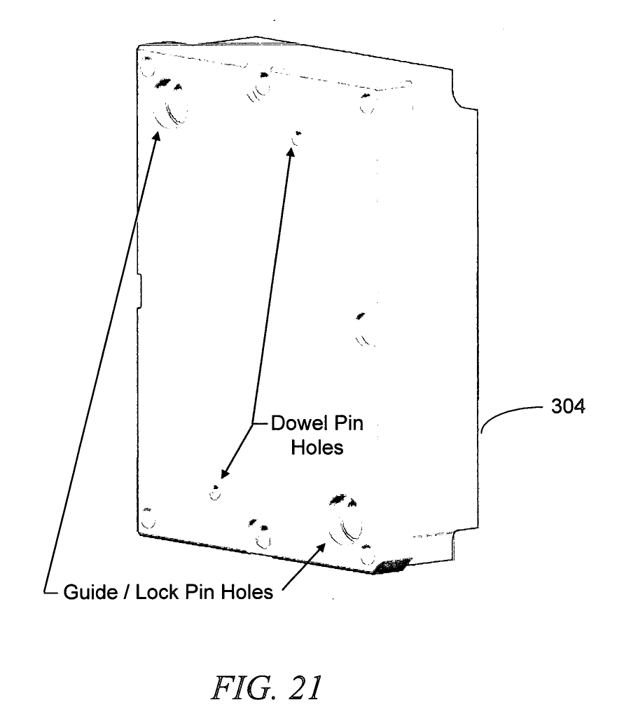

Also as discussed above, in an exemplary embodiment of the present invention, the cavity block 304 must be hardened. Certain machining is performed after hardening of the cavity block 304. This typically includes machining the guide lock pin holes (e.g., by hard machining, jig grinding, or wire electrical discharge machining (EDM)) and machining the dowel pin holes (e.g., by hard machining or jig grinding). Machining of the guide lock pin holes must be in the correct relation to the gate detail location. The c'bore of the guide lock pin holes should not need to be machined but should be checked to confirm the fit of the head of the guide pin. The dowel pin holes are used to align the primary support insert 306 with the core block 304 during assembly, and must be in the correct relation to the corresponding holes in the primary support insert 306. FIG. 21 shows the guide lock pin holes and the dowel pin holes in the core block 304 in accordance with an exemplary embodiment of the present invention.

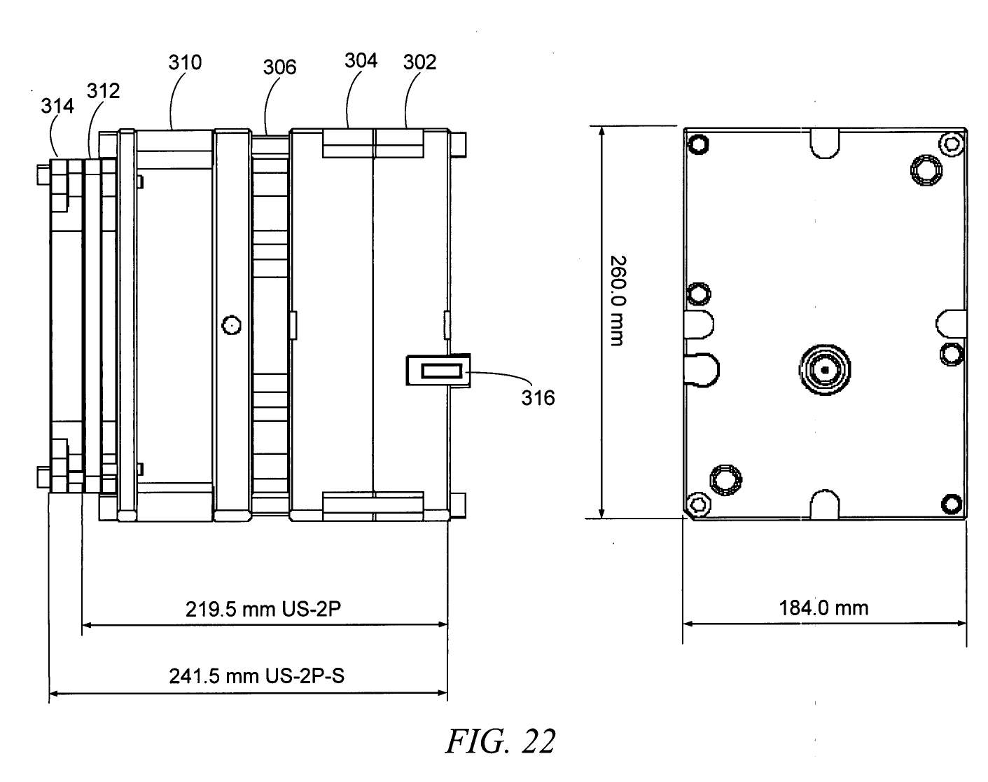

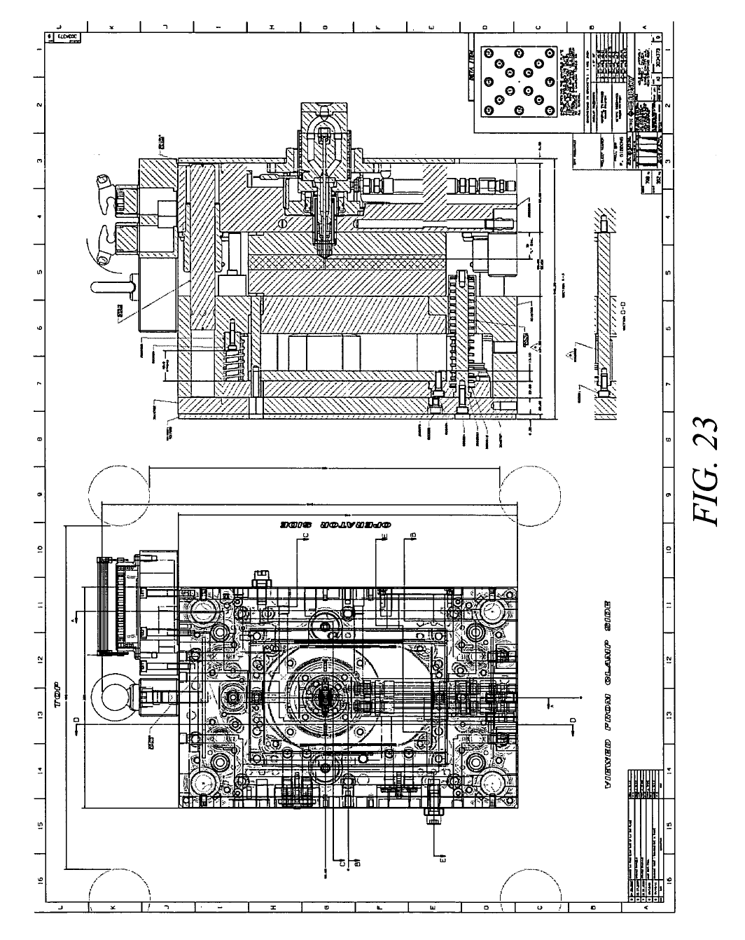

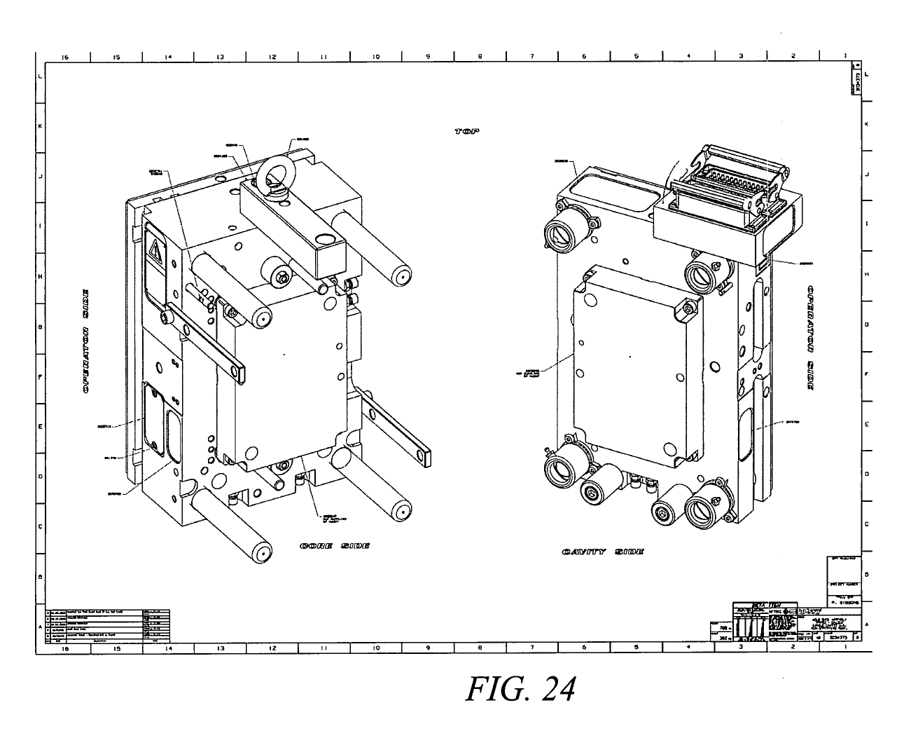

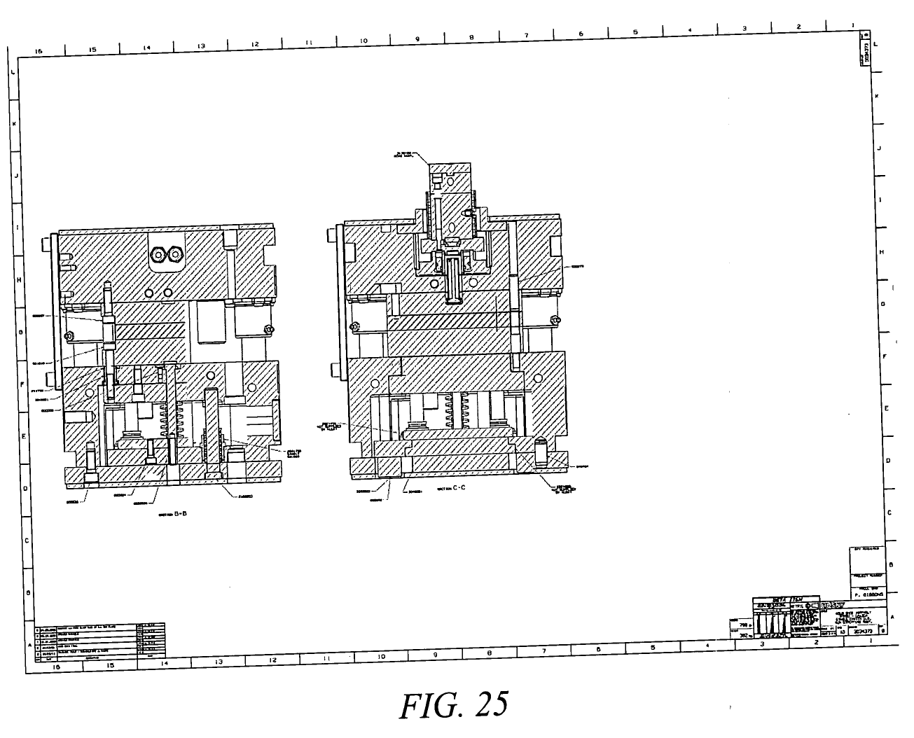

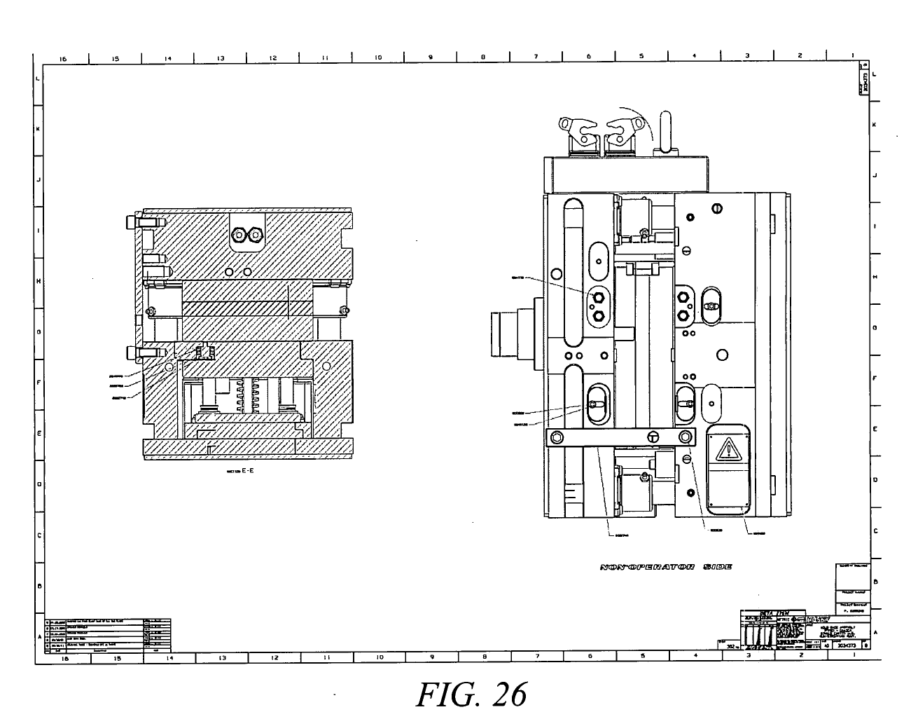

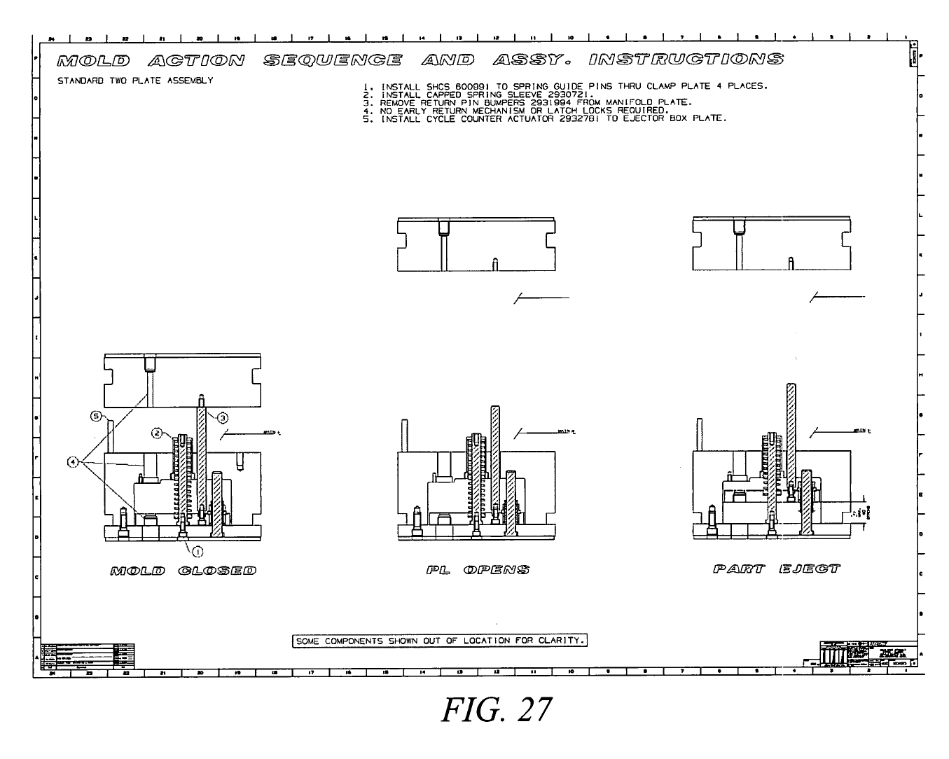

FIG. 22 shows a top view and a side view (from the cavity block 302) of a fully assembled 2P-S stack in accordance with an exemplary embodiment of the present invention. The main difference between the 2P stack and the 2P-S stack is the inclusion of the clamp plate insert 314 in the 2P-S stack. FIG. 23 shows a clamp side view and an operator side view of a fully assembled 2P-S stack in accordance with an exemplary embodiment of the present invention. FIG. 24 shows perspective views of the core side and the cavity side of a 2P-S stack in accordance with an exemplary embodiment of the present invention. FIG. 25 shows additional side views of a fully assembled 2P-S stack in accordance with an exemplary embodiment of the present invention. FIG. 26 shows additional side views of a fully assembled 2P-S stack, including a non-operator side view, in accordance with an exemplary embodiment of the present invention. FIG. 27 shows mold action sequence and assembly instructions for a standard two plate assembly, in accordance with an exemplary embodiment of the present invention. Specifically, the mold is depicted in a closed position, after opening of the parting line prior to ejection, and in an open position after ejection.

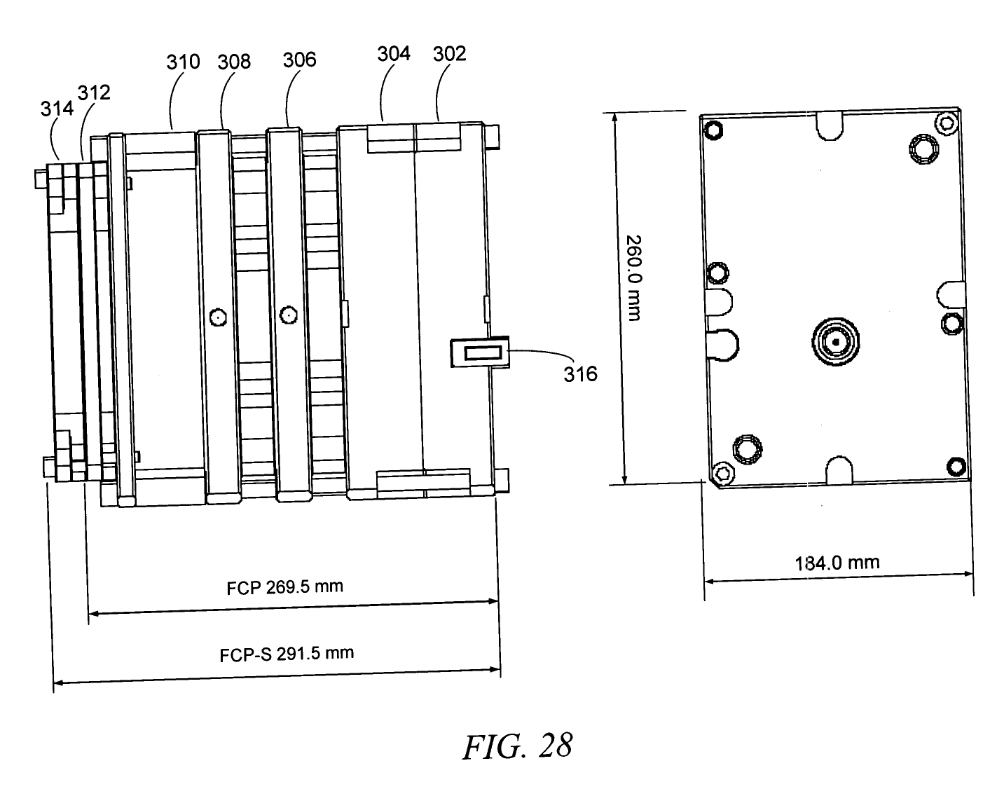

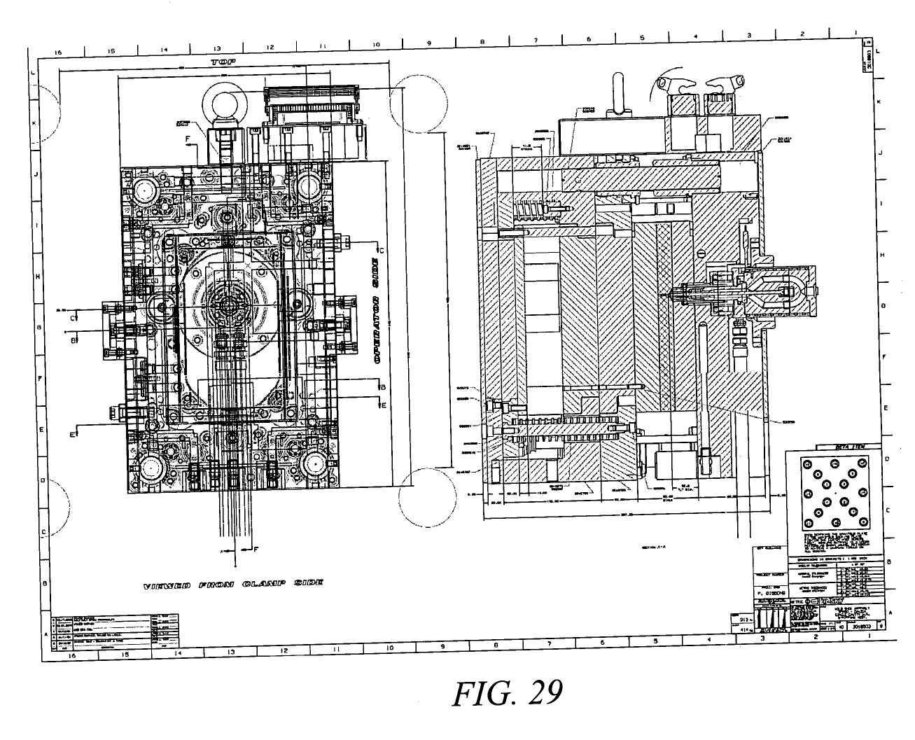

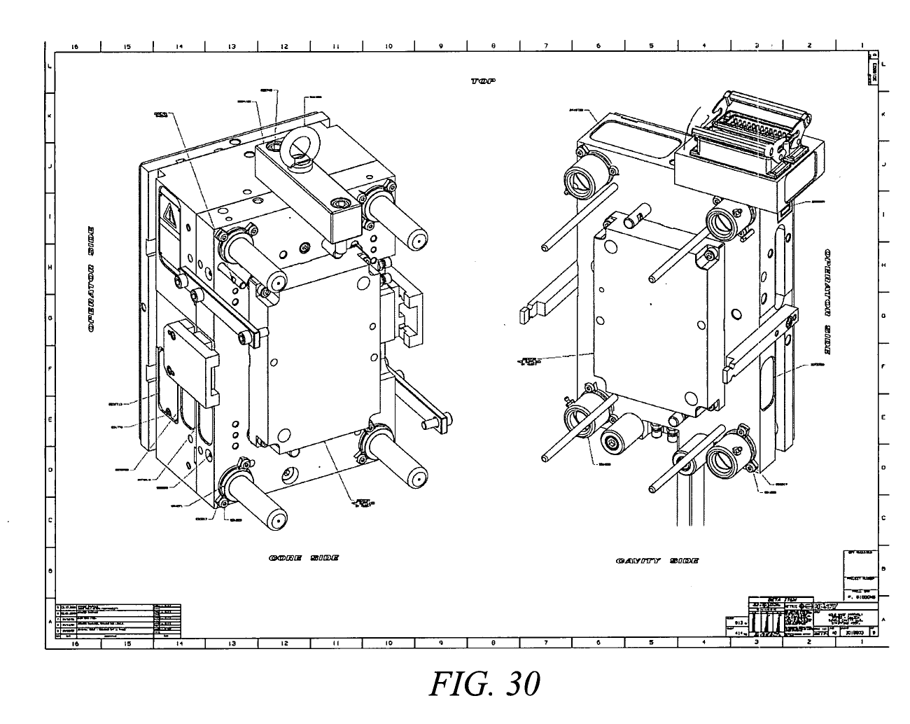

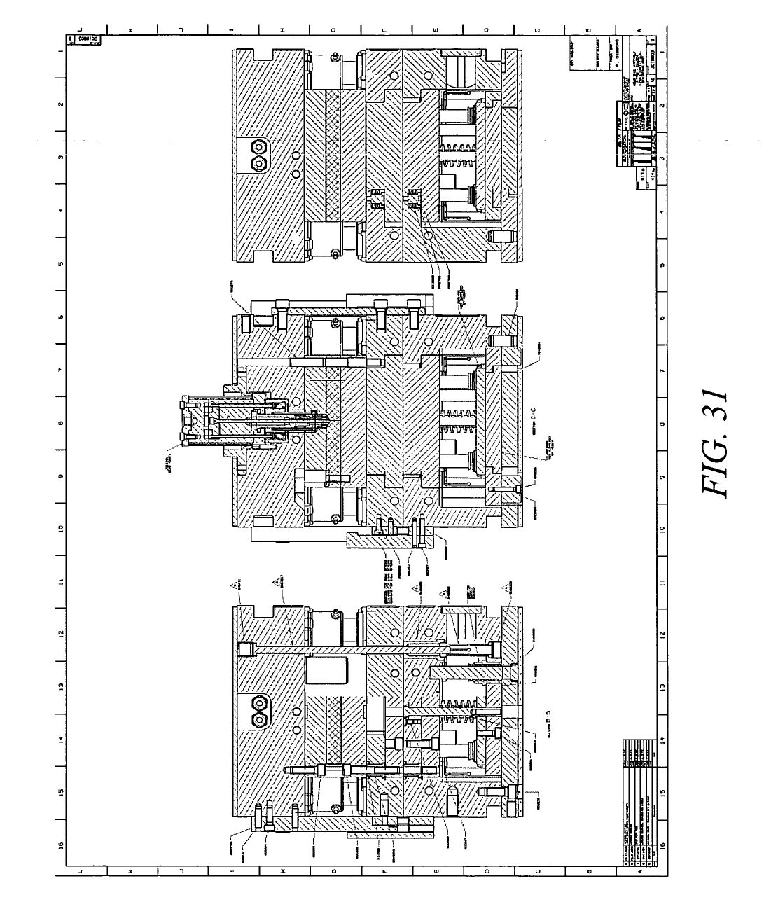

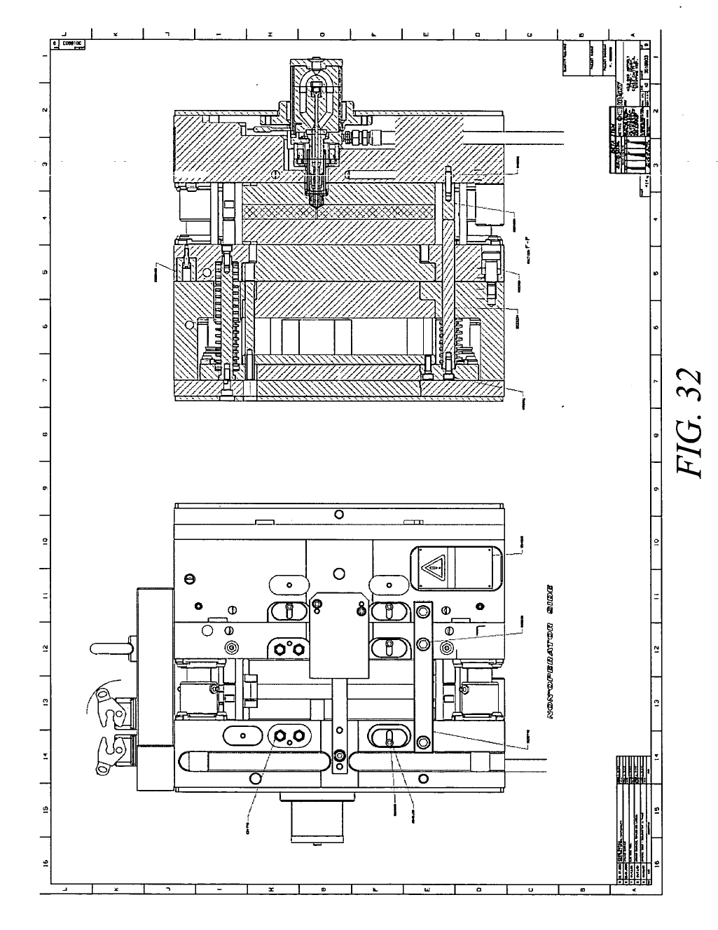

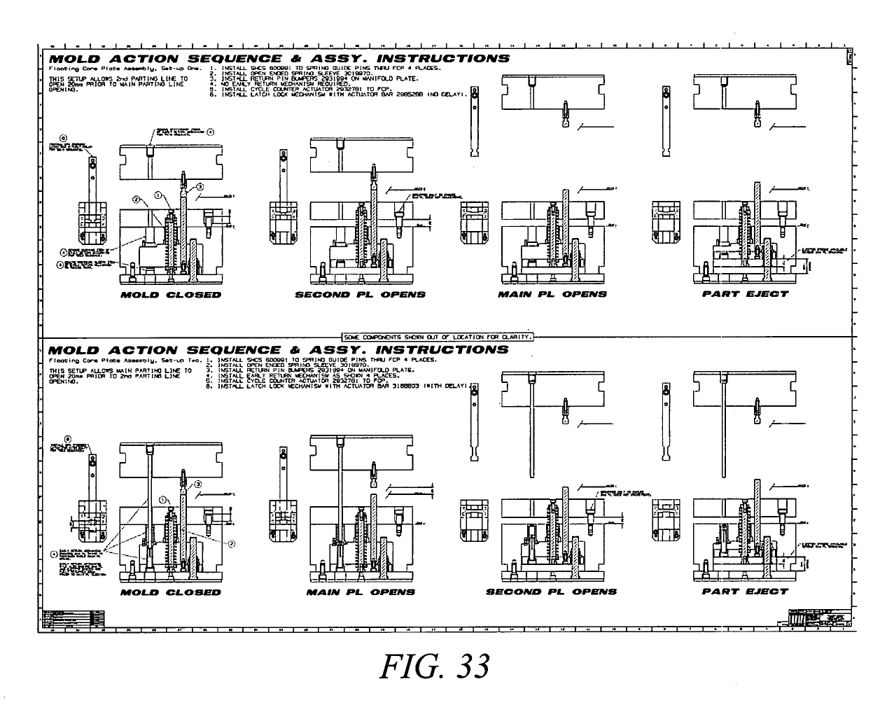

FIG. 28 shows a top view and a side view (from the cavity block 302) of a fully assembled FCP-S stack in accordance with an exemplary embodiment of the present invention. The main difference between the FCP stack and the FCP-S stack is the inclusion of the clamp plate insert 314 in the FCP-S stack. FIG. 29 shows a clamp side view and an operator side view of a fully assembled FCP-S stack in accordance with an exemplary embodiment of the present invention. FIG. 30 shows perspective views of the core side and the cavity side of a FCP-S stack in accordance with an exemplary embodiment of the present invention. FIG. 31 shows additional side views of a fully assembled FCP-S stack in accordance with an exemplary embodiment of the present invention. FIG. 32 shows additional side views of a fully assembled FCP-S stack, including a non-operator side view, in accordance with an exemplary embodiment of the present invention. FIG. 33 shows mold action sequences and assembly instructions for a floating core plate assembly, in accordance with exemplary embodiments of the present invention. In the top half of the drawing, the mold is depicted in a first set-up in which the second parting line opens before the first parting line. Here, the mold is depicted in a closed position, after the second parting line opens, after the main parting line opens, and after ejection. In the bottom half of the drawing, the mold is depicted in a second set-up in which the main parting line opens before the second parting line. Here, the mold is depicted in a closed position, after the main parting line opens, after the second parting line opens, and after ejection.

It should be noted that the blank stacks will be approximately 35 millimeters thicker than shown in FIGS. 22 and 28 due to the additional stock on the cavity block 302 and core block 304, as described with reference to FIG. 8 above.

The present invention may be embodied in other specific forms without departing from the true scope of the invention. The described embodiments are to be considered in all respects only as illustrative and not restrictive.

What is claimed is:

1. Injection molding apparatus comprising a plurality of blank stack components including at least a cavity block, a core block, a primary support insert, a secondary support insert, an ejector retainer plate, an ejector plate insert, and a clamp plate insert, wherein the blank mold components can be assembled into at least four mold configurations including a two plate configuration utilizing the cavity block, the core block, the primary support insert, the ejector retainer plate, and the ejector plate insert; a two plate configuration with sleeves utilizing the cavity block, the core block, the primary support insert, the ejector retainer plate, the ejector plate insert, and the clamp plate insert; a floating core plate configuration utilizing the cavity block, the core block, the primary support insert, the floating core plate support insert, the ejector retainer plate, and the ejector plate insert; and a floating core plate configuration with sleeves utilizing the cavity block, the core block, the primary support insert, the floating core plate support insert, the ejector retainer plate, the ejector plate insert, and the clamp plate insert.

2. Injection molding apparatus according to claim 1, wherein the stacks are interchangeable within standard mold bases having standard interfaces for supporting one or more stacks having any of the four stack configurations.

3. Injection molding apparatus according to claim 2, wherein the mold base includes a standard hot runner, and wherein the cavity block includes a corresponding standard gate position for interfacing with the hot runner.

4. Injection molding apparatus according to claim 2, wherein the mold base includes a standard ejector interface, and wherein the ejector plate insert includes a predetermined area within which ejector components are located.

5. Injection molding apparatus according to claim 2, wherein the mold base includes at least one fluid circuit, and wherein the mold includes corresponding standard inlets and outlets for selectively interfacing with the at least one fluid circuit.

6. Injection molding apparatus according to claim 5, wherein the at least one fluid circuit includes a water circuit for cooling.

7. Injection molding apparatus according to claim 5, further comprising at least one fluid-actuated slider integral to the stack.

8. Injection molding apparatus according to claim 1, wherein the two plate configurations support an opening sequence involving one parting line with no parting line lock or early return mechanism.

9. Injection molding apparatus according to claim 1, wherein the floating core plate configurations are capable of supporting two opening sequences utilizing the same floating core plate.

10. Injection molding apparatus according to claim 9, wherein a first opening sequence involves the use of latch locks with delayed pull bar and early return mechanisms to open a main parting line before opening a second parting line.

11. Injection molding apparatus according to claim 9, wherein a second opening sequence involves the use of latch locks with no delay pull bar and no early return mechanisms to open a second parting line before opening a main parting line.

12. Injection molding apparatus according to claim 2, wherein the core block is movably coupled to a floating core plate or ejector housing plate of the mold base in order to provide a floating core allowing the core block to automatically align with the cavity block when the mold is closed.

13. Injection molding apparatus according to claim 12, further comprising a plurality of spring packs operatively coupled between the floating core plate or ejector housing plate and the primary support insert for holding the core block in a substantially fixed location relative to the cavity block while allowing sufficient movement of the core block for said automatic alignment.

14. Injection molding apparatus according to claim 13, wherein each spring pack comprises a stripper bolt, a number of spring washers arranged on the stripper bolt, and a cap.

15. Injection molding apparatus according to claim 14, wherein each stripper bolt includes a proximal end coupled to the floating core plate or ejector housing plate and a distal end onto which the cap is mounted for making contact with the primary support insert.

16. Injection molding apparatus according to claim 1, wherein the primary support insert, the floating core plate support insert, the ejector retainer plate, the ejector plate insert, and the clamp plate insert are formed from stainless steel so that hardening is not required.

17. Injection molding apparatus according to claim 1, wherein the cavity block and the core block are formed from tool steel that requires hardening.

18. Injection molding apparatus according to claim 17, wherein guide lock pin holes, assembly guide pin holes, and gate detail are formed in the cavity block after hardening.

19. Injection molding apparatus according to claim 17, wherein guide lock pin holes and dowel pin holes are formed in the core block after hardening.

20. Injection molding apparatus according to claim 1, wherein both the blank cavity block and the blank core block include extra material so that a sufficient amount of material, required for a particular application, can be removed from each block to result in a predetermined combined thickness of the two blocks.

21. An injection molding system comprising:
a standard mold base including at least a runner clamp plate and an ejector clamp plate system, the ejector clamp plate system including at least an ejector housing plate, an ejector plate, and a clamp plate and optionally including a floating core plate, the standard mold base having standard interfaces for supporting at least one mold stack; and
at least one mold stack formed from a plurality of blank mold components including at least a cavity block, a core block, a primary support insert, a floating core plate support insert, an ejector retainer plate, an ejector plate insert, and a clamp plate insert, wherein the blank mold components can be assembled into at least four mold configurations including a two plate configuration utilizing the cavity block, the core block, the primary support insert, the ejector retainer plate, and the ejector plate insert; a two plate configuration with sleeves utilizing the cavity block, the core block, the primary support insert, the ejector retainer plate, the ejector plate insert, and the clamp plate insert; a floating core plate configuration utilizing the cavity block, the core block, the primary support insert, the floating core plate support insert, the ejector retainer plate, and the ejector plate insert; and a floating core plate configuration with sleeves utilizing the cavity block, the core block, the primary support insert, the floating core plate support insert, the ejector retainer plate, the ejector plate insert, and the clamp plate insert, wherein each cavity block is attached to the runner clamp plate and wherein the remaining stack components are attached to the ejector clamp plate system.

22. An injection molding system according to claim 21, wherein the two plate stack configurations are used without the optional floating core plate and wherein the floating core plate configurations are used with the optional floating core plate.

23. An injection molding system according to claim 21, wherein the runner clamp plate includes a hot runner for conveying molding material to the at least one mold stack.

24. An injection molding kit having blank stack components capable of being assembled for use in an injection molding system, the kit comprising the combination of:
a cavity block;
a core block;
a primary support insert;
an optional secondary support insert;
an ejector retainer plate;
an ejector plate insert; and
an optional clamp plate insert, wherein the blank stack components can be assembled into at least four mold configurations including a two plate configuration utilizing the cavity block, the core block, the primary support insert, the ejector retainer plate, and the ejector plate insert; a two plate configuration with sleeves utilizing the cavity block, the core block, the primary support insert, the ejector retainer plate, the ejector plate insert, and the clamp plate insert; a floating core plate configuration utilizing the cavity block, the core block, the primary support insert, the secondary support insert, the ejector retainer plate, and the ejector plate insert; and a floating core plate configuration with sleeves utilizing the cavity block, the core block, the primary support insert, the secondary support insert, the ejector retainer plate, the ejector plate insert, and the clamp plate insert.

25. An injection molding kit according to claim 24, further comprising latch locks which, when used with the floating core plate configurations, allows for opening a second parting line before opening a main parting line.

26. An injection molding kit according to claim 24, further comprising latch locks with delayed pull bar and early return mechanisms which, when used with the floating core plate configurations, allows for opening a main parting line before opening a second parting line.
